(19) United States
(12) Patent Application Publication
(10) Pub. No.: US 2015/0130701 A1
(43) Pub. Date: May 14, 2015

(54) ARRANGEMENT FOR PHYSICALLY MOVING TWO DIMENSIONAL, THREE DIMENSIONAL AND/OR STEREOSCOPIC THREE DIMENSIONAL VIRTUAL OBJECTS

(71) Applicant: JUMBO VISION INTERNATIONAL PTY LTD, Mawson Lakes, South Australia (AU)

(72) Inventor: Gerhard Kimenkowski, Mawson Lakes (AU)

(21) Appl. No.: 14/401,906

(22) PCT Filed: May 16, 2013
(86) PCT No.: PCT/AU2013/000505

§ 371 Date: Nov. 18, 2014

(30) Foreign Application Priority Data
May 18, 2012 (AU) 2012902045

(51) Int. Cl. G06F 3/0346; G06T 19/20

(52) U.S. Cl. CPC G06F 3/0346; G06T 19/20; G06T 2210/04; G06T 2219/2016
USPC 345/156

(57) ABSTRACT

An arrangement for moving virtual object images within a real space. The arrangement includes a virtual object image creator. A tangible object in electrical and/or electronic communication with the virtual object image creator such that when a virtual object image is generated by the virtual object image creator, electrical and/or electronic communication between the tangible object and the generated virtual object image is such, that upon movement of the tangible object there is a translation to corresponding movement of the generated virtual object image within the real space.

### TECHNOLOGICAL FIELD

This invention relates to the generating of two dimensional, three dimensional and/or stereoscopic three dimensional images in open real spaces such as a room, office, factory and so forth. Wherein such generated images assist in initial designing considerations before the corresponding physical object of the virtual generated image is installed or located in that particular location and/or space.

### BACKGROUND ART DISCUSSION

Throughout the specification reference is made to 3D or three dimensional, this terminology also encompasses stereoscopic 3D or generation of other forms of virtual objects allowed by improvements in technology in the future.

Given the kinds of costs involved these days in fitting out homes, offices, factories, hospitals and even certain military layouts, it is now possible through image generation to construct a virtual two dimensional and/or three dimensional and/or stereoscopic three dimensional image of a series of objects such as desks, screens and monitors, bedding, electronic and military installations, stairways, just to name a few.

For the most part one central computer provides the two dimensional and/or three dimensional rendered representation which then is extracted out to work in communication with image apparatuses at the location such as a series of projectors, lasers and so forth wherein the required images are then generated either in two dimension and/or three dimensional and/or stereoscopic three dimensional.

If these generated two dimensional and/or three dimensional and/or stereoscopic three dimensional images need to be relocated or moved to another position for the most part there is the requirement then to work on the main created software application on a computer or so forth where the design has been previously saved and updated or alter the file in such a way so that the movement of the generated two dimensional and/or three dimensional and/or stereoscopic three dimensional image is able to be relocated from one place to the other within the open space.

While this is perfectly adequate in some scenarios, there is still the requirement however for the movement of the generated two dimensional and/or three dimensional and/or stereoscopic three dimensional image to be completed away from the object itself.

It would part be particularly advantageous to have the ability to, in a sense, in real time and almost with a physical ability to be able to shift a generated two dimensional and/or three dimensional and/or stereoscopic three dimensional image from one location to the other without having to go back to the main central computer or outlet where the application for manipulation of the generated two dimensional and/or three dimensional and/or stereoscopic three dimensional image was first created.

This is similar in application for example to a situation where one may have bought a table which is to be positioned in a room or even a picture frame that is to be placed upon the wall.

Under this scenario the person attempting to decide where that table or picture frame is best suited within the room or upon the wall would physically lift that object of the picture frame or table to the other preferred location in real time through a physical task of actually engaging the object.

As is to be expected, a virtually generated two dimensional and/or three dimensional and/or stereoscopic three dimensional image cannot be physically engaged as it is simply a generated image rather than a tangible object.

However the ability to be able to in a sense physically engage with that generated two dimensional and/or three dimensional and/or stereoscopic three dimensional image would be advantageous because once again a person could act independently of the computer program that has generated the image and walk over to the generated two dimensional and/or three dimensional and/or stereoscopic three dimensional image and simply move it from one place to the other as one would do with a physical tangible object.

Therefore it is an object of this invention to provide a means for physically moving a two dimensional and/or three dimensional and/or stereoscopic three dimensional generated virtual image from one location to another without the requirement of having to utilise programmable means from a separate computer terminal and so forth.

Further objects and advantages of the invention will become apparent from a complete reading of the specification.

### SUMMARY OF THE INVENTION

Accordingly in one form of the invention there is an arrangement for the relocating of a two dimensional and/or three dimensional and/or stereoscopic three dimensional virtual object image within a real space, said arrangement including:

a two dimensional and/or three dimensional and/or stereoscopic three dimensional virtual object image creator;

a tangible object in electrical and/or electronic communication with said two dimensional and/or three dimensional and/or stereoscopic three dimensional virtual object image creator;

such that when a two dimensional and/or three dimensional and/or stereoscopic three dimensional virtual object image is generated by the two dimensional and/or three dimensional and/or stereoscopic three dimensional virtual object image creator, electrical and/or electronic communication between the tangible object and the generated two dimensional and/or three dimensional and/or stereoscopic three dimensional virtual object image is such, that upon movement of the tangible object there is a translation to corresponding movement of the two dimensional and/or three dimensional and/or stereoscopic three dimensional generated virtual object image within the real space.

In preference the tangible object is positioned in a first location wherein the two dimensional and/or three dimensional and/or stereoscopic three dimensional virtual object image has been initially generated within the real space.

In preference movement of the tangible object from the first location to a second location corresponds to movement of the generated two dimensional and/or three dimensional and/or stereoscopic three dimensional virtual object image from said first location to said second location within the real space.

An advantage of such an arrangement is that for the first time like in the conventional situation where there is an actual physical tangible object and one would like to move it from one point to another within a room and so forth to determine its suitability relative to another location in real time and so forth by simply lifting up, moving or dragging the object from point A to point B, this same type of scenario now exists and is made possible by this unique arrangement provided for by this invention.

As each generated two dimensional and/or three dimensional and/or stereoscopic three dimensional virtual object image has a corresponding tangible object to engage which represents that particular generated image, a user now simply only has to pick up that tangible object move it from point A over to Point B and at the same time that generated two dimensional and/or three dimensional and/or stereoscopic three dimensional virtual object image will follow within the real space.

Advantageously there is no requirement to have a separate person manipulating the saved file of the generated virtual images from a computer and so forth, or for in fact the person to move across to a control station for operating the generated virtual images. In this unique invention all the use will have to do is engage the tangible object which corresponds with the associated generated two dimensional and/or three dimensional and/or stereoscopic three dimensional virtual object image and move that in real time and be satisfied immediately as to whether or not the relocation of the virtual object from point A to point B is preferable.

The physical benefits of being able to pick up an object and move it instantaneously from one point to another has now become a reality even in the world of virtual created object images because in this invention importantly for every image that has been created virtual there will be a corresponding tangible object associated with that virtual generated image so that any movement of that tangible object will be correlated or translated to the generated virtual image to move or be shifted from one location to another.

In preference the tangible object includes a user operable computer with a display screen.

In preference the tangible object further includes a keypad, keyboard and/or touch screen for operability with the computer.

In preference the tangible object including the user operable computer with a display screen and the keypad, keyboard and/or touch screen is supported on an adjustable column.

In preference the tangible object is a portable computer tablet or smart phone.

In preference the portable computer tablet or smart phone is supported on an adjustable stand.

In preference the computer, portable computer tablet or smart phone includes a software application for user interfacing such that the computer portable computer tablet or smart phone allows user interaction so as to adjust dimensions of the generated two dimensional and/or three dimensional and/or stereoscopic three dimensional virtual object image.

In preference the computer, portable computer tablet or smart phone includes a software application for user interfacing such that the computer portable computer tablet or smart phone allows user interaction so as to adjust colours of the generated two dimensional and/or three dimensional and/or stereoscopic three dimensional virtual object image.

In preference the computer, portable computer tablet or smart phone includes a software application for user interfacing such that the computer portable computer tablet or smart phone allows user interaction so as to adjust design appearance of the generated two dimensional and/or three dimensional and/or stereoscopic three dimensional virtual object image.

An advantage of such an arrangement is that when the user looks at a particular generated virtual object image, it may well be that they would like to decide upon whether that particular article which has been represented by the virtual image object would be more appropriate, say for example, with different dimensions, colours and/or design appearance.

The tangible object within the preferred embodiment may take the shape of a device that would include further electronic and electrical functionality that would allow the user to interface with the computer, portable computer tablet or smart phone so as to enlarge or reduce the size of a particular article that has been generated as a virtual object image.

As is to be appreciated the arrangement could even allow for the manipulation of items upon a desk. For example computers, additional monitors, shelving and so forth could all be inter-related back to a single tangible object which includes the computer interfacing which would allow their unique manipulation not only from point A to point B within a particular room environment, but also to separate locations say for example upon a desk or table.

In preference a group of generated two dimensional and/or three dimensional and/or stereoscopic three dimensional object images are in electrical and/or electronic communication with the tangible object within the real space.

In this invention it will be possible to generate a whole series of virtual images so that a multiplicity of work benches, furniture, electronic and/or military installation devices, hospital appliances and so forth could all be presented relative as required to surrounded articles in a particular environment whether it would be one in the home, the office, the factory, the hospital, military observation and so forth.

Advantageously however with this invention given for every generated two dimensional and/or three dimensional and/or stereoscopic three dimensional virtual object image there will be a corresponding tangible physical object which will be able to relocate and manipulate the virtual generated image, means that individuals can walk about the confines of that environment and in a sense in a real time physically and independently engage that object moving it from one point to another or altering its dimensions as required so that an appreciation of that generated object relative to another generated virtual object can be compared.

For example in a military situation those observing a particular conflict could be in a room and particular locations are mapped out as generated two dimensional images on the ground wherein military installations or troop deployment can be also generated as three dimensional and/or stereoscopic three dimensional images one against the other.

Under such a scenario people who need to make decisions based on how these generated images are inter-engaging, can relocate them utilising conventional means of simply walking over to that virtual object and once again in a sense physically moving it from one location to the other by engaging the tangible object which is associated with that virtually generated object image.

In the hospital environment where not only aesthetics needs to be taken into consideration, but real practical health and occupational safety issues need to be considered, before expensive hospital equipment is installed and placed in locations which would be relative to beds and so forth, the overall layout and suitability can be determined before those corresponding real products are placed within the room.

In preference a user of the arrangement would wear stereoscopic glasses to view a generated stereoscopically three dimensional virtual object image.

Advantageously however with this invention once the virtual images have been generated the person will be free to enter the real open space, such as a room and so forth, and simply engage that generated virtual image object in a real sense by grabbing the tangible object and as it is associated with the generated virtual image be able to move it from one point to the other and in some embodiments also be able to manipulate the dimensions and/or particular characteristics of the virtual object being moved and relocated.

In order to understand the invention now in greater detail a preferred embodiment will be presented herewith the assistance of the following illustrations and accompanying text.

While a preferred embodiment details the application of this invention to an office type environment, as introduced above numerously, this invention can be equally applied to other environments including the home, factory, hospitals, military and surveillance.

### BRIEF DESCRIPTION OF THE DRAWINGS

FIG. 1 is a schematic representation of a preferred embodiment of this invention illustrating the generation of virtual object images.

FIG. 2 is a similar schematic representation to that of FIG. 1 however what is further illustrated is the engagement of the tangible object that corresponds with the generated virtual object image and the movement of the physical object that translates to correlated movement of the generated virtual object image.

FIG. 3 shows a schematic view to highlight the movement of the virtual generated object image by moving the physical tangible object associated with said generated virtual object image.

FIG. 4 is a schematic representation illustrating the functionality of the physical tangible object that will also have means to allow the generated virtual object image to which it relates, to have its dimensions altered.

### DETAILED DESCRIPTION OF THE INVENTION

Referring to the drawings now in greater detail wherein a general arrangement for in a sense physically moving generated virtual three dimensional objects is shown as (10) which includes a series of vertical projectors (14) supported on framework structure (12) and a series of lateral or horizontal projections (18) supported on wall (16).

Projectors (14) and (18) assist in the generation of the various three dimensional object images (20) and (22).

It needs to be appreciated that the way in which the virtual images are generated through projection is not an essential aspect of this invention. There will be a variety of ways in which two dimensional and three dimensional and/or stereoscopic three dimensional images can be generated as objects. The purpose of this invention is the manipulation of these generated virtual object images by being able to relocate them through the use of tangible physical objects which a user can grab and move from point A to point B as required in order to relocate the generated virtual image.

The generated three dimensional object images shown generally as (20) includes what best could be described as a desk (24) and a corresponding chair (25).

On top of the desk there are other generated virtual object images shown generally as (26A), (26B) and (26C).

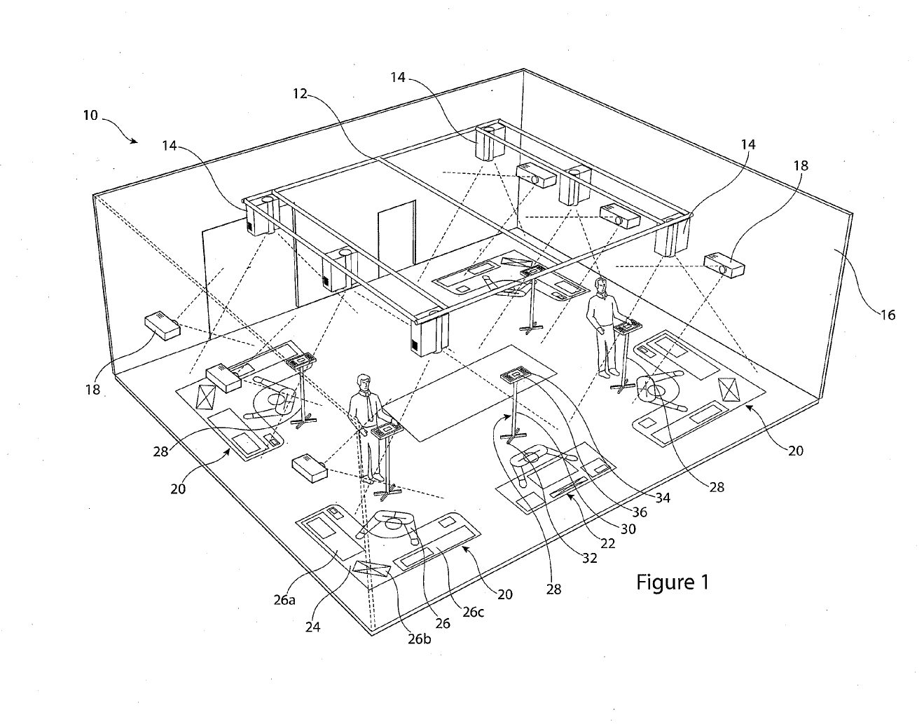

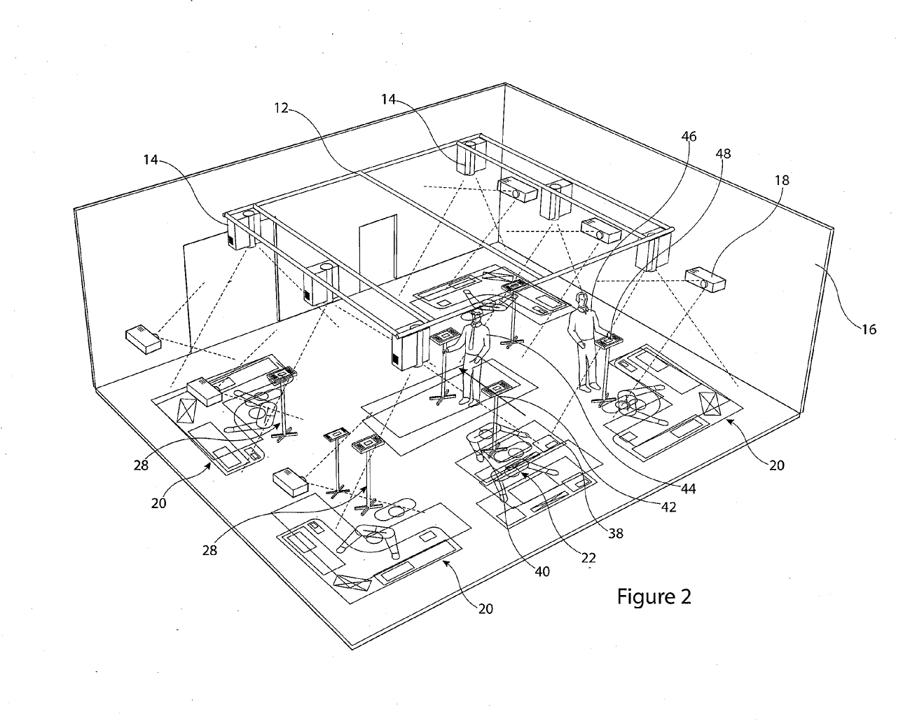

A generated three dimensional object image (20) in the embodiment shown in FIGS. 1 and 2 has been for the most part located in four locations in general alignment with the corners of the room.

As best seen in FIG. 2 the three dimensional virtual object image (22) includes the desk (38) and the chair (40).

The tangible objects associated with each generated virtual object images (20) and (22) are represented as the control stand and panels (28).

In the embodiment shown in FIGS. 1 and 2 that physical tangible object (28) has the main support column (30), base support (32), computer (34) and user interface (36).

As best seen in FIG. 2 there are two users of the arrangement (44) and (46). For user (44) by virtue of the shown arrow (42) has carried the tangible object (28) from one location to the other.

As can be seen this then correlates to actual movement of the virtual generated three dimensional object image (22) wherein the grouping of the desk (38) and chair (40) also move in the same direction caused by the corresponding movement of the tangible object (28) which the user (44) has shifted.

Therefore as can be appreciated, a user can walk about the room, assess one generated virtual object image to another and then, if required, can in real time without the requirement of having to re-program a generated image and so forth, simply take hold of the tangible object (28) associated with a particular generated virtual image and move that physical tangible object (28) to a preferred location for further comparisons to be made.

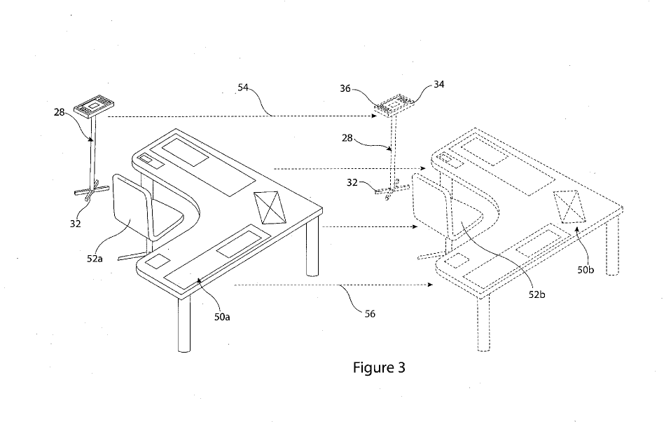

FIG. 3 shows in greater detail how for example a group of articles such as a desk or table (50a) and a chair (52a) are generated as a single virtual three dimensional object image which are associated with the physical tangible object (28) which when moved from a first location to second location, illustrated by way of broken arrows (54) and (56) results in the image being relocated and represented as (50b) for the table and (52b) for the chair in the second location.

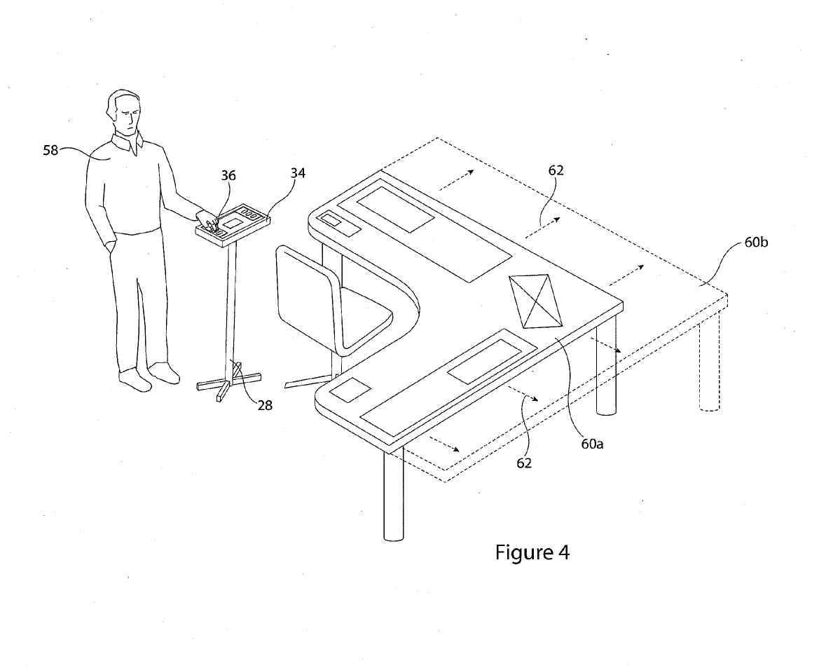

In FIG. 4 further functionality of the tangible object (28) is provided for wherein the computer (34) and the user interface (36) would allow a user (58) to also be able to manipulate a particular generated virtual image which in this instance is shown as a table (60a).

The user (58) by manipulating a computer (34) can expand out the dimensions shown by way of arrows (62) to provide a generated virtual object image (68b) which is still the initial design of the virtual object image (60a) however just simply larger.

1. An arrangement for the relocating three dimensional virtual object images within a real non electronic space, said arrangement including:
a three dimensional virtual object image creator adapted to project a plurality of three dimensional virtual object images in a real non electronic space;
a plurality of tangible objects, wherein each tangible object is located within a corresponding three dimensional virtual object image;
such that upon physical movement of each tangible object within a real non electronic space there is a corresponding physical movement of the three dimensional virtual object image within the same real non electronic space of the corresponding tangible object.

2. (canceled)

3. (canceled)

4. The arrangement of claim 1 wherein the tangible object includes a user operable computer with a display screen wherein the operable computer with the display screen further includes a keypad, keyboard and/or touch screen for operability, wherein the operable computer with the display screen is supported on an adjustable column located within the three dimensional virtual object image.

5. (canceled)

6. (canceled)

7. (canceled)

8. (canceled)

9. The arrangement of claim 4 wherein the operable computer includes a software application for user interfacing so as to adjust dimensions of the generated three dimensional virtual object image.

10. The arrangement of claim 4 wherein the operable computer includes a software application for user interfacing so as to adjust colours of the generated three dimensional virtual object image.

11. The arrangement of claim 4 wherein the operable computer includes a software application for user interfacing so as to adjust design appearance of the generated three dimensional virtual object image.

12. (canceled)

13. (canceled)
